(19) United States
(12) Patent Application Publication
(10) Pub. No.: US 2011/0312427 A1
(43) Pub. Date: Dec. 22, 2011

(54) SHAFT BODY COMPRISING AN INTEGRATED OIL SEPARATOR UNIT

(75) Inventors: Jürgen Meusel, Dittmansdorf (DE); Ulf Müller, Chemnitz (DE); Andreas Stapelmann, Chemnitz (DE); Daniel Paul, Burkansdorf (DE)

(73) Assignee: Thyssenkrupp Presta Teccenter AG, Eschen (LI)

(21) Appl. No.: 13/203,895

(22) PCT Filed: Jan. 16, 2010
(86) PCT No.: PCT/EP2010/000230

§ 371 Date: Aug. 30, 2011

(30) Foreign Application Priority Data
Mar. 10, 2009 (DE) 10 2009 012 402.0

(51) Int. Cl. F16C 3/02

(52) U.S. Cl. 464/183

(57) ABSTRACT

The invention relates to a shaft body (2) that is rotatably mounted in a bearing unit (4), comprising an oil separator unit that is integrated into a cavity (3) of the shaft body (2). According to the invention, at least one discharge opening (3a; 3b) is provided in the case of the shaft body (2), said opening communicating with a drain channel (4a; 4b) of the bearing unit (4).

The present invention refers to a shaft body, especially to a camshaft with integrated oil separation device according to the preamble of claim 1.

A hollow shaft, constructed as a camshaft, with integrated separation device, is already known from WO 2006/119737 A1, wherein in addition to a preseparator, which is arranged on the outer periphery of the camshaft, provision is made for a swirler as a final separator, which is integrated into the cavity of the camshaft.

The present invention is based on the object of providing a generic-type shaft body with integrated oil separation device, by means of which a type of construction which is as compact and space saving as possible is ensured.

According to the invention, this object is achieved by means of a shaft body with the features of patent claim 1. Owing to the fact that the at least one discharge opening (especially the oil discharge opening) which is arranged on the convex surface side and essentially radially—advantageously all the existing discharge openings for the oil which is to be discharged and the gas which is to be discharged—is, or are, arranged in the region of a bearing unit which encompasses the shaft body, and that the at least one discharge opening of the shaft body corresponds to at least one corresponding discharge passage of the bearing unit, an exceptionally space saving and compact type of construction of the shaft body with integrated oil separation device is ensured. In a simple embodiment, the draining of the separated oil could be carried out by means of one or more radial, convex surface-side discharge openings in the shaft body, which correspond to at least one discharge passage of the bearing unit, whereas the discharging of the gas flow could be carried out axially via the open end of the hollow shaft body. For the preferred case in which both the draining of the oil and the discharging of the cleaned gas are to be carried out via radial, convex surface-side discharge openings, the at least one convex surface-side gas discharge opening is arranged downstream of the at least one convex surface-side oil discharge opening, as seen in the flow direction. For diverting the axially flowing air or gas flow into the radially arranged (convex surface-side) gas discharge openings of the shaft body wall, a correspondingly designed flow guiding element is provided in the cavity of the shaft body. This flow guiding element can be designed as a plug-like component in such a way that the axially flowing gas is diverted at least in part in the direction of the at least one gas discharge opening. To this end, the flow guiding element can be essentially of a conical design and orientated by its cone point against the flow direction. The flow guiding element can be of a design which is impermeable by gas or air so that the entire gas flow is diverted/discharged radially outwards into the gas discharge opening(s) by means of the flow guiding element. Alternatively, the flow guiding element can also be designed in such a way that it axially passes through a predetermined gas or air flow in the case of a known flow pressure, while the remaining portion is diverted/discharged radially outwards into the gas discharge openings. In another possible embodiment, the flow element can also have an axial bypass channel which, via a pressure-dependent bypass valve (for example with a spring force-loaded check valve), is opened when a predetermined pressure is exceeded so that when the predetermined pressure is exceeded a portion of the cleaned gas flow is discharged via the bypass valve and a remaining portion is discharged via the convex surface-side gas discharge opening(s).

The integrated oil separation device is advantageously of a multistage construction. In this case, a first oil separation stage is advantageously formed by means of a so-called swirler. This swirler can be designed, for example, as a body which extends in the cavity of the shaft body in the axial direction and which circumferentially has at least one screw thread flight in such a way that by means of the screw thread flight a flow passage for guiding the introduced oil-laden gas or oil-laden (or laden with oil droplets) air (subsequently also referred to as blow-by gas or oil mist) is formed between the body of the swirler and the inner wall of the shaft body. A second oil separation stage can be formed by means of an oil separation ring which is arranged downstream of the swirler, as seen in the flow direction. In this case, the oil separation ring is advantageously of a solid design in such a way that in the edge-side flow region of the cavity of the shaft body it constitutes a corresponding flow obstruction for the oil-enriched gas (or air) in this region (on account of the rotation/centrifugal force).

Further advantages, features and expedient developments of the invention come from the dependent claims and from the subsequent illustrations of preferred exemplary embodiments.

In the drawings:

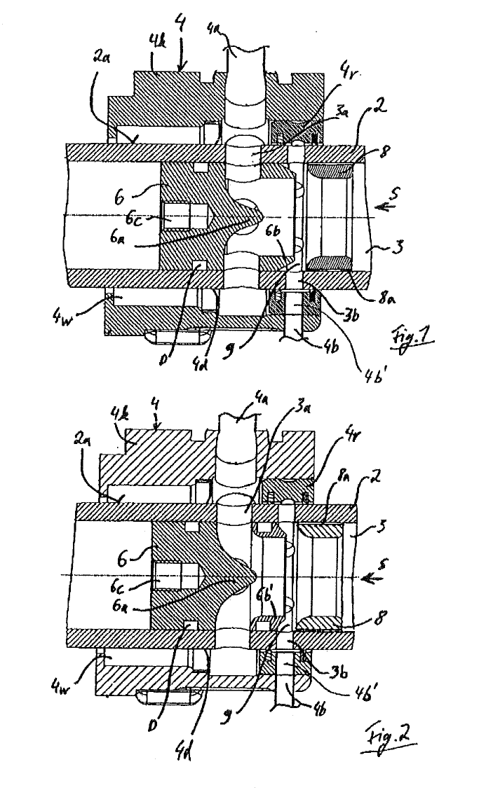

FIG. 1 shows a section of the shaft body according to the invention, with the convex surface-side discharge passages for oil and gas which are arranged in the region of a bearing unit which supports the shaft body, in a first possible embodiment, as seen in longitudinal section,

FIG. 2 shows a further possible embodiment of the shaft body according to the invention with a slightly modified construction of the flow guiding element,

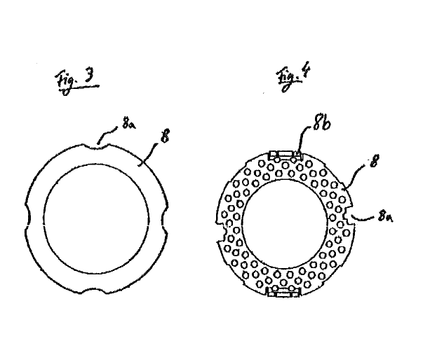

FIG. 3 shows an oil separation ring in a possible first embodiment, as seen in cross section, and

FIG. 4 shows the oil separation ring according to FIG. 3 in a further possible embodiment, as seen in partial cross section.

In FIG. 1, a shaft body 2, rotatably supported in a bearing unit 4 and designed as a hollow shaft, with integrated oil separation device, is shown in a partial longitudinal section. The bearing unit 4 comprises a bearing body 4k which can be constructed either in the form of a bearing block (formed by means of a part of the cylinder head, for example) or which can be constructed as a separate component which can be fastened on the cylinder head. For the rotatable support of the shaft body 2, the bearing unit 4 can be constructed in the form of the bearing body 4k which on its hollow-cylindrical inner surface is designed in such a way to form a friction bearing together with a hardened region (bearing section 2a) of the shaft body 2. In another embodiment of the bearing unit 4, this can have a multiplicity of rolling elements 4w over its hollow-cylindrical inner surface, by means of which the shaft body 2—which is surface-hardened at least in sections—is rotatably supported. In the latter, also in the case which is illustrated in FIGS. 1 and 2, the bearing unit has a sealing ring 4d by means of which the adjacent gas discharge passage 4a is sealed in relation to the region with rolling elements 4w. As a result of this, the effect of uncleaned gas being drawn into the gas discharge passage and being fed to the internal combustion engine is prevented.

The shaft body 2 has at least one essentially radial discharge opening 3b for draining the oil which is separated from the so-called blow-by gas. According to the depicted embodiment, there are radial discharge openings 3a, 3b for gas and oil, wherein the shaft body 2 is supported in the region of the discharge openings 3a, 3b by means of the bearing unit 4. For discharging the cleaned gas and for draining the separated oil, the bearing unit 4 has a discharge passage 4a; 4b for gas or oil which corresponds in each case to the respective discharge opening 3a; 3b. In the region of the oil discharge openings 3b, a radial sealing ring 4r, which has at least one oil passage 4b′ which corresponds to the oil discharge opening 3b and also to the oil discharge passage 4b, is arranged in the bearing unit 4 or in its bearing body 4k. On its inner surface, the radial sealing ring 4r has a circumferential groove N in which the oil which is deposited on the inner wall of the hollow body 2 and exits through the circumferentially distributed oil discharge openings 3b can be received and discharged via the oil passage 4b′ which opens into the groove N. By means of the radial sealing ring 4r, which is retained circumferentially in the bearing unit 4 in a frictionally engaging manner and which via its sealing lips, which are oriented inwards towards the shaft body surface, is sealed in relation to the shaft body 2 which rotates in the radial sealing ring 4r, a reliable draining of the separated oil is ensured and drawing in of oil into the adjacent gas discharge passage 4a is reliably prevented.

In the depicted embodiment, the shaft body 2 is retained in a rotatably supported manner in the bearing unit 4 via the rolling elements 4w. The bearing section(s) 2a of the shaft body 2 which interact(s) with the rolling elements 4w (rolling bearings) or with regions of the bearing body 4k (friction bearing) can be constructed as a hardened and/or surface-treated shaft body section, or sections. If the bearing unit 4 is not constructed as a friction bearing but as a rolling bearing, provision is made in the bearing unit 4 or in the bearing body 4k for regions which are free of rolling elements for arranging the discharge openings for oil or for oil and gas. In the region of the shaft body 2 in which this interacts with the bearing unit 4 or is enclosed by this, provision is made for at least one radial discharge opening (or discharge hole) 3a, 3b for discharging gas or oil. A plurality of holes, which are arranged in each case in an annularly distributed manner over the circumference of the shaft body 2, are advantageously provided as discharge openings for gas or oil in such a way that a ring of holes, consisting of a multiplicity of holes which are arranged in an annularly distributed manner over the circumference, is formed for discharging the cleaned blow-by gases, and a ring of holes is formed for draining the oil which is separated from the blow-by gas. Each convex surface-side discharge opening 3a, 3b interacts in this case with a discharge passage 4a, 4b which is formed in the bearing unit 4 or in the bearing body 4k and corresponds to the respective discharge opening 3a, 3b. The discharge passage 4a, 4b which corresponds to the respective discharge opening(s) 3a, 3b is constructed inside the bearing unit 4 as an annular passage with at least one corresponding radial discharge section for discharging the oil or gas which is to be discharged from the shaft body 2.

In order to be able to separately discharge the blow-by gas with its separated constituents, having already been basically separated into its gas and oil constituents in the region of the discharge openings 3a, 3b, a flow guiding element 6 is arranged inside the cavity 3 of the shaft body 2, by means of which the axially flowing gas flow is deflected into the at least one radial gas discharge opening 3a. In this case, the flow guiding element 6 is provided circumferentially with a sealing element D in order to be able to discharge all the gas portions of the cleaned blow-by gas as far as possible via the radial discharge openings 3a. To this end, the flow guiding element 6 is designed essentially like a plug or cork and on its end face which faces the inflowing gas flow has a basically centrally orientated conical extension 6a. On the opposite end face, the flow guiding element 6 has a threaded hole 6c. This threaded hole serves especially for simpler removal of the depicted device. In order to be able to separately drain the oil which has been deposited by means of the integrated oil separation device on the inner wall 2b of the shaft body 2, an oil guiding element 6b is arranged between the oil discharge opening 3b and the at least one gas discharge opening 3a which is arranged downstream of the at least one oil discharge opening 3b, as seen in the flow direction S. The oil guiding element 6b, as shown in FIG. 1, can be constructed in one piece with the flow guiding element 6. In another embodiment of the invention, as is shown according to FIG. 2, the oil guiding element 6b′ can be designed as a separate component in the form of an individual separation ring which is arranged between the gas discharge openings 3a and the oil discharge openings 3b.

The integrated oil separation device advantageously comprises at least two differently acting oil separation elements. In this case, a first oil separation element is designed in the form of a so-called swirler (not shown), for example, whereas a second oil separation element is constructed in the form of an oil separation ring 8 which is located downstream of the first oil separation element, as seen in the flow direction S. As a result of the geometric arrangement of the oil separation ring 8, which is arranged directly upstream of the oil discharge opening 3b, as seen in the flow direction S, and of the oil guiding element 6b; 6b′, which is arranged directly downstream of the oil discharge opening 3b (but still upstream of the gas discharge opening 3a), as seen in the flow direction S, a flow-calmed region 9 is formed. On account of the flow-calmed region 9, efficient draining of oil and also improved separation (or maintaining of the separation) between the clean gas constituents and the separated oil constituents can be achieved.

In FIGS. 3 and 4, a possible embodiment of an oil separation ring is shown in each case. According to FIG. 3, the oil separation ring 8 is essentially of a solid design and constitutes a large flow obstruction in the form of an impingement element for the flow of the blow-by gas in the region of the inner wall of the shaft body 2. The oil particles which are suspended in the blow-by gas cannot follow the quick change of direction on the oil separation ring 8, impinge against the end face of the oil separation ring 8, and so are separated out from the oil mist. Circumferentially, the oil separation ring 8 has a multiplicity of axially extending recesses 8a via which the oil particles which are deposited on the wall side or the oil film which is formed therefrom on the wall side, can flow further in the flow direction S in the direction of the oil discharge opening 3b.

The oil separation ring 8 advantageously has a system of interconnected cavities so that a labyrinth of cavities, which penetrates the oil separation ring 8, is formed. The end face of the oil separation ring 8 additionally constitutes an impingement element, whereas the inner labyrinth is a combination of impingement and deflection elements. By means of these impingement and deflection elements, lighter oil particles are also separated out from the oil mist so that the oil mist which flows downstream of the oil separation ring 8, as seen in the flow direction S, can be considered to be cleaned gas or cleaned air. Materials for the aforesaid configurations of the oil separation ring 8 may be, for example, porous plastics or synthetic materials. The oil separation ring 8 preferably also comprises a plastic mesh and/or metal mesh which forms, or form, a large number of cavities and labyrinths, wherein the oil separation ring 8 then preferably comprises a support ring which supports the mesh and, moreover, serves for fixing the mesh in the cavity 3 of the shaft body 2. In one embodiment of the oil separation ring 8, as is illustrated according to FIG. 4, the oil separation ring 8 comprises a perforated sheet-metal ring. Such an oil separation ring 8 advantageously comprises a multiplicity of sheet-metal rings which are arranged in series and rotated or offset in relation to each other in the respective hole rows or hole patterns and which are spaced apart and interconnected via circumferential connecting elements 8b. As a result of the offset or the rotation of the individual sheet-metal rings in relation to each other and the corresponding spacing apart of the individual sheet-metal rings, a corresponding labyrinth is created for separating oil out from the blow-by gas which flows through the oil separation ring 8.

### LIST OF DESIGNATIONS

Shaft body 2
Bearing section (shaft body) 2a
Cavity 3
Discharge opening (gas) 3a
Discharge opening (oil) 3b
Bearing unit 4
Bearing body 4k
Rolling element 4w
Radial sealing ring 4r
Discharge passage (gas) 4a
Discharge passage (oil) 4b
Oil passage (radial sealing ring) 4b′
Sealing ring 4d
Flow guiding element 6
Extension 6a
Oil guiding element 6b; 6b′
Threaded hole (flow guiding element) 6c
Oil separation ring 8
Recess (oil separation ring) 8a
Flow-calmed region 9
Flow direction S
Sealing element D
Groove (radial sealing ring) N

1. Shaft body (2), especially camshaft, rotatably supported in a bearing unit (4), with an oil separation device integrated into a cavity (3) of the shaft body (2), wherein
the shaft body (2) has at least one feed opening for the introduction of oil-laden gas into the cavity (3), and
the shaft body (2) has at least one discharge opening (3a; 3b) for draining separated oil and for discharging gas which is freed of oil,
characterized in that
the at least one discharge opening (3a; 3b) is arranged in the shaft body (2) on the convex surface side and the bearing unit (4) has a discharge passage (4a; 4b) corresponding to the discharge opening (3a; 3b).

2. Shaft body (2) according to claim 1, characterized in that the bearing unit (4) comprises a bearing body (4k) and the at least one discharge opening (3a; 3b) of the shaft body (2) corresponds to the at least one discharge opening (4a; 4b) in the bearing body (4k).

3. Shaft body (2) according to claim 1, characterized in that the bearing unit (4) comprises a rolling bearing.

4. Shaft body (2) according to claim 1, characterized in that the bearing unit (4) comprises a friction bearing.

5. Shaft body (2) according to claim 1, characterized in that the at least one discharge opening (3a; 3b) is constructed as a radial hole in the shaft body (2).

6. Shaft body (2) according to claim 1, characterized in that the oil separation device includes a swirler.

7. Shaft body (2) according to claim 1, characterized in that the oil separation device includes an oil separation ring (8) which is arranged coaxially in the cavity (3) of the shaft body (2).

8. Shaft body (2) according to claim 6, characterized in that the oil separation ring (8) is arranged downstream of the swirler, as seen in the flow direction (S).

9. Shaft body (2) according to claim 1, characterized in that there is at least one gas discharge opening (3a) and at least one oil discharge opening (3b) which is separate from this.

10. Shaft body (2) according to claim 9, characterized in that the at least one gas discharge opening (3a) is arranged downstream of the at least one oil discharge opening (3b), as seen in the flow direction (S).

11. Shaft body (2) according to claim 10, characterized in that an annular oil guiding element (6b; 6b′) is arranged between the at least one gas discharge opening (3a) and the at least one oil discharge opening (3b).

12. Shaft body (2) according to claim 1, characterized in that a radial sealing ring (4r), which encompasses the shaft body, is arranged in the bearing unit (4) and has at least one oil passage (4b′) which corresponds to the oil discharge opening (3b) and also to the oil discharge passage (4b).

13. Shaft body (2) according to claim 1, characterized in that inside the cavity (3), downstream of the at least one gas discharge opening (3a), as seen in the flow direction S, provision is made for a flow guiding element (6) for at least partially deflecting the axially flowing gas, cleaned of oil, in the direction of the at least one convex surface-side gas discharge opening (3a).

14. Shaft body (2) according to claim 13, characterized in that the flow guiding element (6) has a centrally arranged, essentially conically formed extension (6a), orientated by its point against the flow direction 5, which directs the axial flow in the direction of the convex surface-side gas discharge opening (3a).
